(19) United States
(12) Patent Application Publication
(10) Pub. No.: US 2026/0236680 A1
(43) Pub. Date: Aug. 13, 2026

(54) Method, System, and Computer Program Product for Improving Large Language Models

(71) Applicant: Visa International Service Association, San Francisco, CA (US)

(72) Inventors: Debdeep Bandyopadhyay, Shibpur (IN); Shivam Mohan, Lucknow (IN); Vinay Sarda, Bikaner (IN); Dheeraj Dhamija, Bengaluru (IN); Mansi Singh, Bhopal (IN); Ravi Shanker Kumar Sinha, Bengaluru (IN)

(21) Appl. No.: 19/052,620

(22) Filed: Feb. 13, 2025

(51) Int. Cl. G06F 40/284

(52) U.S. Cl. CPC G06F 40/284

(57) ABSTRACT

Methods, systems, and computer program products are provided for improving LLMs which include: receiving a prompt from a user device of a user; in response to receiving the prompt, automatically generating a response to the prompt by: inputting user data associated with the user to a reinforcement learning model; determining a first decoding method from a plurality of decoding methods based at least partially on the user data; inputting the prompt to an LLM; and generating a first token of the response based at least partially on the prompt and using the first decoding method; and communicating the response to the user device.

### BACKGROUND

### 1. Technical Field

This disclosure relates generally to large language models (LLMs) and, in some non-limiting embodiments or aspects, to methods, systems, and computer program products for improving LLMs.

### 2. Technical Considerations

Existing LLMs use a single, specific decoding method to determine the next token/word from a corpus of data. However, the selection process for the next token follows a standard method which might not always give the desired result and does not match and/or adapt with a user's intentions or preferences. This can lead to suboptimal or irrelevant outputs by the LLM.

### SUMMARY

Accordingly, provided are improved methods, systems, and computer program products for improving LLMs.

According to non-limiting embodiments or aspects, provided is a computer-implemented method for improving LLMs. The method may include receiving, with a large language model system, a prompt from a user device of a user; in response to receiving the prompt, automatically generating, with the large language model system, a response to the prompt by: inputting user data associated with the user to a reinforcement learning model of the large language model system; determining, with the reinforcement learning model, a first decoding method from a plurality of decoding methods based at least partially on the user data; inputting the prompt to a large language model (LLM) of the large language model system; and generating, with the LLM, a first token of the response based at least partially on the prompt and using the first decoding method; and communicating, with the large language model system, the response to the user device.

In some non-limiting embodiments or aspects, the first token may correspond to at least one word or phrase of the response.

In some non-limiting embodiments or aspects, the first decoding method may include a deterministic decoding method, where the first token may be a token selected from a plurality of tokens, where the first token may be generated based on the first token having a highest relevance scored compared to other tokens from the plurality of tokens.

In some non-limiting embodiments or aspects, the first decoding method may include a non-deterministic decoding method, where the first token may be a token selected from a plurality of tokens, where the first token may be generated based on the first token being randomly selected from a subset of n-tokens of the plurality of tokens, the subset of n-tokens having a higher relevance scored compared to other tokens from the plurality of tokens, where n may be 2 or more.

In some non-limiting embodiments or aspects, automatically generating the response to the prompt may further include: in response to generating the first token, determining, with the reinforcement learning model, a second decoding method from the plurality of decoding methods; and generating, with the LLM, a second token of the response based at least partially on the prompt and using the second decoding method.

In some non-limiting embodiments or aspects, the response may include a string of words and/or phrases corresponding to the first token and the second token.

In some non-limiting embodiments or aspects, the second decoding method may be different from the first decoding method.

In some non-limiting embodiments or aspects, determining the second decoding method may be based at least partially on feedback data, the feedback data generated by and/or provided to the reinforcement learning model in between the generation of the first token and the determination of the second decoding method.

In some non-limiting embodiments or aspects, the feedback data may include at least one of the following: an n-gram comparison of a human-generated response to a portion of the response generated by the LLM, where n is 1 or more; a perplexity score representing a confidence of the LLM in predicting a next token of the response; at least one of the following scores: a Bilingual Evaluation Understudy (BLEU) score, a Recall-Oriented Understudy for Gisting Evaluation (ROUGE) score, a Metric for Evaluation of Translation with Explicit Ordering (METEOR) score, a Word Error Rate (WER) score, a Character Error Rate (CER) score, and/or any combination thereof; and/or any combination thereof.

In some non-limiting embodiments or aspects, the feedback data may include a feedback score based on an algorithm weighting the n-gram comparison, the perplexity score, and the at least one of the following scores.

In some non-limiting embodiments or aspects, the feedback data may be generated by and/or provided to the reinforcement learning model in between each token generated by the LLM.

In some non-limiting embodiments or aspects, the user data may include user profile data and/or historical user interaction data.

In some non-limiting embodiments or aspects, the computer-implemented method may further include: after communicating the response to the user device, receiving, with the large language model system and from the user device, user feedback data associated with the response; and training the reinforcement learning model based on the user feedback data.

In some non-limiting embodiments or aspects, the computer-implemented method may further include: receiving, with the large language model system, a second prompt from the user device of the user; in response to receiving the second prompt, automatically generating, with the large language model system, a second response to the second prompt by: inputting the user feedback data to the reinforcement learning model; determining, with the reinforcement learning model, a second decoding method from the plurality of decoding methods based at least partially on the user feedback data; inputting the second prompt to the LLM; and generating, with the LLM, a first token of the second response based at least partially on the second prompt and using the second decoding method.

In some non-limiting embodiments or aspects, the user feedback data may include explicit feedback data including at least one of the following: a user input in which at least one parameter of the LLM is tuned, a user input indicating direct approval or disapproval of the response, and/or any combination thereof.

In some non-limiting embodiments or aspects, the user feedback data may include implicit feedback data including feedback inferred by the large language model system from a second prompt received from the user device after the user device receives the response.

In some non-limiting embodiments or aspects, the LLM may be a generative artificial intelligence model configured to generate the response in real time relative to receiving the prompt.

In some non-limiting embodiments or aspects, a first portion of the response may be generated by the LLM using the first decoding method, and a second portion of the response may be generated by the LLM using a second decoding method different from the first decoding method.

According to non-limiting embodiments or aspects, provided is a system for improving LLMs. The system may include at least one processor configured to: receive a prompt from a user device of a user; in response to receiving the prompt, automatically generate a response to the prompt by: inputting user data associated with the user to a reinforcement learning model of the large language model system; determining, with the reinforcement learning model, a first decoding method from a plurality of decoding methods based at least partially on the user data; inputting the prompt to a large language model (LLM) of the large language model system; and generating, with the LLM, a first token of the response based at least partially on the prompt and using the first decoding method; and communicate the response to the user device.

According to non-limiting embodiments or aspects, provided is a computer program product for improving LLMs. The computer program product may include at least one non-transitory computer-readable medium including program instructions that, when executed by a large language model system, cause the large language model system to: receive a prompt from a user device of a user; in response to receiving the prompt, automatically generate a response to the prompt by: inputting user data associated with the user to a reinforcement learning model of the large language model system; determining, with the reinforcement learning model, a first decoding method from a plurality of decoding methods based at least partially on the user data; inputting the prompt to a large language model (LLM) of the large language model system; and generating, with the LLM, a first token of the response based at least partially on the prompt and using the first decoding method; and communicate the response to the user device.

Further non-limiting embodiments or aspects are set forth in the following numbered clauses:
Clause 1: A computer-implemented method, comprising: receiving, with a large language model system, a prompt from a user device of a user; in response to receiving the prompt, automatically generating, with the large language model system, a response to the prompt by: inputting user data associated with the user to a reinforcement learning model of the large language model system; determining, with the reinforcement learning model, a first decoding method from a plurality of decoding methods based at least partially on the user data; inputting the prompt to a large language model (LLM) of the large language model system; and generating, with the LLM, a first token of the response based at least partially on the prompt and using the first decoding method; and communicating, with the large language model system, the response to the user device.
Clause 2: The computer-implemented method of clause 1, wherein the first token corresponds to at least one word or phrase of the response.
Clause 3: The computer-implemented method of clause 1 or 2, wherein the first decoding method comprises a deterministic decoding method, wherein the first token is a token selected from a plurality of tokens, wherein the first token is generated based on the first token having a highest relevance scored compared to other tokens from the plurality of tokens.
Clause 4: The computer-implemented method of any of clauses 1-3, wherein the first decoding method comprises a non-deterministic decoding method, wherein the first token is a token selected from a plurality of tokens, wherein the first token is generated based on the first token being randomly selected from a subset of n-tokens of the plurality of tokens, the subset of n-tokens having a higher relevance scored compared to other tokens from the plurality of tokens, wherein n is 2 or more.
Clause 5: The computer-implemented method of any of clauses 1-4, wherein automatically generating the response to the prompt further comprises: in response to generating the first token, determining, with the reinforcement learning model, a second decoding method from the plurality of decoding methods; and generating, with the LLM, a second token of the response based at least partially on the prompt and using the second decoding method.
Clause 6: The computer-implemented method of any of clauses 1-5, wherein the response comprises a string of words and/or phrases corresponding to the first token and the second token.
Clause 7: The computer-implemented method of any of clauses 1-6, wherein the second decoding method is different from the first decoding method.
Clause 8: The computer-implemented method of any of clauses 1-7, wherein determining the second decoding method is based at least partially on feedback data, the feedback data generated by and/or provided to the reinforcement learning model in between the generation of the first token and the determination of the second decoding method.
Clause 9: The computer-implemented method of any of clauses 1-8, wherein the feedback data comprises at least one of the following: an n-gram comparison of a human-generated response to a portion of the response generated by the LLM, wherein n is 1 or more; a perplexity score representing a confidence of the LLM in predicting a next token of the response; at least one of the following scores: a Bilingual Evaluation Understudy (BLEU) score, a Recall-Oriented Understudy for Gisting Evaluation (ROUGE) score, a Metric for Evaluation of Translation with Explicit Ordering (METEOR) score, a Word Error Rate (WER) score, a Character Error Rate (CER) score, and/or any combination thereof; and/or any combination thereof.
Clause 10: The computer-implemented method of any of clauses 1-9, wherein the feedback data comprises a feedback score based on an algorithm weighting the n-gram comparison, the perplexity score, and the at least one of the following scores.
Clause 11: The computer-implemented method of any of clauses 1-10, wherein the feedback data is generated by and/or provided to the reinforcement learning model in between each token generated by the LLM.
Clause 12: The computer-implemented method of any of clauses 1-11, wherein the user data comprises user profile data and/or historical user interaction data.
Clause 13: The computer-implemented method of any of clauses 1-12, further comprising: after communicating the response to the user device, receiving, with the large language model system and from the user device, user feedback data associated with the response; and training the reinforcement learning model based on the user feedback data.
Clause 14: The computer-implemented method of any of clauses 1-13, further comprising: receiving, with the large language model system, a second prompt from the user device of the user; in response to receiving the second prompt, automatically generating, with the large language model system, a second response to the second prompt by: inputting the user feedback data to the reinforcement learning model; determining, with the reinforcement learning model, a second decoding method from the plurality of decoding methods based at least partially on the user feedback data; inputting the second prompt to the LLM; and generating, with the LLM, a first token of the second response based at least partially on the second prompt and using the second decoding method.
Clause 15: The computer-implemented method of any of clauses 1-14, wherein the user feedback data comprises explicit feedback data comprising at least one of the following: a user input in which at least one parameter of the LLM is tuned, a user input indicating direct approval or disapproval of the response, and/or any combination thereof.
Clause 16: The computer-implemented method of any of clauses 1-15, wherein the user feedback data comprises implicit feedback data comprising feedback inferred by the large language model system from a second prompt received from the user device after the user device receives the response.
Clause 17: The computer-implemented method of any of clauses 1-16, wherein the LLM is a generative artificial intelligence model configured to generate the response in real time relative to receiving the prompt.
Clause 18: The computer-implemented method of any of clauses 1-17, wherein a first portion of the response is generated by the LLM using the first decoding method, and a second portion of the response is generated by the LLM using a second decoding method different from the first decoding method.
Clause 19: A system, comprising a large language model system configured to: receive a prompt from a user device of a user; in response to receiving the prompt, automatically generate a response to the prompt by: inputting user data associated with the user to a reinforcement learning model of the large language model system; determining, with the reinforcement learning model, a first decoding method from a plurality of decoding methods based at least partially on the user data; inputting the prompt to a large language model (LLM) of the large language model system; and generating, with the LLM, a first token of the response based at least partially on the prompt and using the first decoding method; and communicate the response to the user device.
Clause 20: A computer program product comprising at least one non-transitory computer-readable medium including program instructions that, when executed by a large language model system, cause the large language model system to: receive a prompt from a user device of a user; in response to receiving the prompt, automatically generate a response to the prompt by: inputting user data associated with the user to a reinforcement learning model of the large language model system; determining, with the reinforcement learning model, a first decoding method from a plurality of decoding methods based at least partially on the user data; inputting the prompt to a large language model (LLM) of the large language model system; and generating, with the LLM, a first token of the response based at least partially on the prompt and using the first decoding method; and communicate the response to the user device.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of an interactive system, according to some non-limiting embodiments or aspects;

FIG. 2 is a schematic diagram of an LLM-generated response, according to some non-limiting embodiments or aspects;

FIG. 3 is a schematic diagram of feedback, according to some non-limiting embodiments or aspects;

FIG. 4 is a schematic diagram of feedback, according to some non-limiting embodiments or aspects;

FIGS. 5A-5C are schematic diagrams of user interfaces displaying user prompts and LLM responses, according to some non-limiting embodiments or aspects;

FIG. 6 is a schematic diagram of decoding models, according to some non-limiting embodiments or aspects;

FIG. 7 is a flow diagram for an example process for improving LLMs, according to some non-limiting embodiments or aspects;

FIG. 8 is a schematic diagram of an example electronic payment processing network, according to some non-limiting embodiments or aspects; and

FIG. 9 is a schematic diagram of example components of one or more devices of FIG. 1, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the terms “client” and “client device” may refer to one or more client-side devices or systems. As an example, a “client device” may refer to one or more computing devices. In some non-limiting embodiments or aspects, a client device may be an electronic device configured to communicate with one or more networks. For example, a client device may include one or more computers, portable computers, laptop computers, tablet computers, mobile devices, cellular phones, wearable devices (e.g., watches, glasses, lenses, clothing, and/or the like), PDAs, and/or the like.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a payment device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like, operated by or on behalf of a payment gateway.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for improving LLMs. For example, non-limiting embodiments or aspects include a reinforcement learning model configured to enable a LLM system including an LLM to select and use the decoding method most suitable for generating the next token for a response to a user prompt. As opposed to the LLM utilizing a single decoding method to generate the entire response, the LLM has a plurality of different decoding methods available for use in generating the tokens that form the response. The LLM may use a single decoding method of the plurality of decoding methods to generate the entire response if the single decoding method is most suitable for generating each token of the response. However, the LLM is enabled by the present disclosure to use multiple decoding methods in generating the response, such as by using a first decoding method for generating one or more tokens of the response and using a second decoding method for generating one or more tokens of the same response.

Non-limiting embodiments or aspects utilize the reinforcement learning model for determining the most suitable decoding method for generating the next token. For example, the reinforcement learning model may use user data associated with the user submitting the prompt for determining the most suitable decoding method for generating the next token. In this way, the LLM system reinforcement learning model may select the decoding method(s) most suitable for generating the next token of the response for that specific user. This enables the LLM system to adapt responses based on user preferences.

Non-limiting embodiments or aspects enable the LLM system to dynamically select the same or different decoding method for the next token based on a feedback model. The feedback may be generated by the reinforcement learning model in between each token generated by the LLM, in between each phrase generated by the LLM (e.g., bigram feedback and/or n-gram feedback), or after generation of the response. This dynamic selection of the best decoding strategy in between each token and/or each response may allow LLM system to explore different ways of generating relevant responses and avoid being stuck in local optima. The feedback model may provide its feedback based on training data of the reinforcement learning model (e.g. human annotated feedback used to train the reinforcement learning model). This may allow the LLM system to pivot between decoding methods in between each token or combination of tokens generated by the LLM to improve responses generated by the LLM.

Non-limiting embodiments or aspects enable the LLM system to be improved in generating future responses based on user feedback, such as by implicit and/or explicit feedback of the user to a prior response of the LLM. This user feedback may be used to further train the LLM and/or the reinforcement learning model (e.g. human annotated feedback used to train the reinforcement learning model). This may allow the LLM system to improve future response of the LLM to user prompts.

For the purpose of illustration, in the following description, while the presently disclosed subject matter is described with respect to methods, systems, and computer program products for improving LLMs, one skilled in the art will recognize that the disclosed subject matter is not limited to the illustrative embodiments.

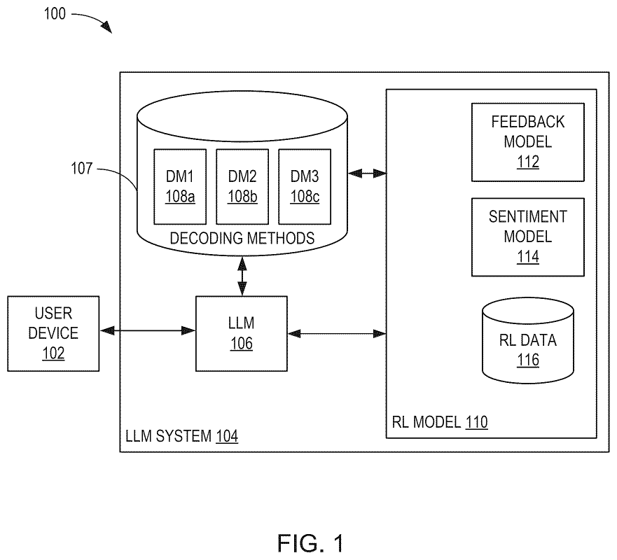

FIG. 1 depicts a non-limiting embodiment or aspect of an interactive system 100 in which a user device 102 of a user interacts with an LLM system 104 comprising an LLM 106. In the interactive system 100, the user device 102 may interact with LLM system 104 by communicating a prompt to LLM 106 to cause LLM system 104 to generate and return a response to the prompt. The prompt may comprise a question, a request, an inquiry, a command, and/or the like. The response may comprise an answer to the prompt. The response may be automatically generated by LLM system 104 as described herein in response to receiving the prompt. The response may be generated and returned to user device 102 in real time relative to receiving the prompt (e.g., in real-time, in near real-time, during the event, as soon as practically available after the event, during processing and/or communication of messages related to the event, at the time of making a decision related to the event (e.g., receiving the prompt). For example, the term “real time” may refer to performance of a task or tasks during another process or before another process is completed. LLM system 104 may comprise one or more generative artificial intelligence models configured to generate a response in real time relative to receiving the prompt. The generative artificial intelligence model may be configured to create new content (e.g., text, images, audio and/or video) in response to receiving an input. LLM 106 may comprise a generative artificial intelligence model.

User device 102 may include at least one computing device, as described herein. In some non-limiting embodiments or aspects, user device 102 may include at least one processor (e.g., a multi-core processor) such as a graphics processing unit (GPU), a central processing unit (CPU), an accelerated processing unit (APU), a microprocessor, and/or the like. User device 102 may communicate with LLM system 104.

LLM system 104 may include at least one computing device, as described herein. In some non-limiting embodiments or aspects, LLM system 104 may include at least one processor (e.g., a multi-core processor) such as a graphics processing unit (GPU), a central processing unit (CPU), an accelerated processing unit (APU), a microprocessor, and/or the like. LLM system 104 may include LLM 106, decoding method database (DM data) 107 storing a plurality of decoding methods 108a-108c (DM1-DM3), and/or reinforcement learning model (RL model) 110. RL model 110 may comprise a feedback model 112, a sentiment model 114, and/or a reinforcement learning database (RL data) 116. RL model 110 may be configured to make a decision based on the option that would maximize the reward to the model, such as based on feedback data.

LLM 106 may include at least one computing device as described herein. For example, LLM 106 may include a computer (e.g., portable computer, non-mobile computer, and/or the like), a server (e.g., a single server), a group of servers, and/or other like devices of a user. In some non-limiting embodiments or aspects, LLM 106 may include at least one processor (e.g., a multi-core processor) such as a graphics processing unit (GPU), a central processing unit (CPU), an accelerated processing unit (APU), a microprocessor, and/or the like. In some non-limiting embodiments or aspects, LLM 106 may include memory, one or more storage components, one or more input components, one or more output components, and/or one or more communication interfaces, as described herein. The LLM 106 may comprise a natural language processing system. LLM 106 may be configured to simulate how a human would behave as a conversational partner. Non-limiting examples of LLMs include CHATGPT, GEMINI, CLAUDE, LLAMA, and the like.

Decoding methods 108a-108c may each comprise a one or more models (e.g., machine-learning models) configured to generate one or more tokens in response to receiving an input. The machine learning model (or any machine learning model described herein) may include at least one neural network, at least one multilayer perceptron (MLP), at least one deep neural network (DNN), at least one attention model, at least one self-attention model, at least one multi-head self-attention model, at least one transformer model, at least one vision transformer (ViT) model, at least one convolutional neural network (CNN), at least one tree model, and/or the like. The model may, for example, receive (as the input) one or more vectors corresponding to a prompt from user device 102 and execute one or more software functions to process the prompt and generate one or more tokens for a response to the prompt. The tokens may correspond to a word and/or a phrase of the response. Each of the models corresponding to decoding methods 108a-108c may be stored in DM data 107. One or more of decoding methods 108a-108c may be invoked by LLM 106 to generate a response to the prompt.

RL model 110 may comprise one or more models (e.g., machine-learning models) configured to generate one or more outputs in response to receiving an input. RL model 110 may comprise a reinforcement learning model trained to generate a decision configured to maximize cumulative rewards in a given situation. RL model 110 may be trained using training data and make decisions based on the training. RL model 110 may be trained to determine a decoding method from a plurality of decoding methods 108a-108c to be used to generate a next token in the response to the prompt. RL model 110 may determine the decoding method based at least partially on user data corresponding to the user submitting the prompt. RL model 110 may be trained on any corpus of data suitable for selecting a next decoding method for the next token.

Feedback model 112 of RL model 110 may comprise one or more models (e.g., machine-learning models) configured to generate feedback data for RL model 110. Sentiment model 114 of RL model 110 may comprise one or more models (e.g., machine-learning models) configured to generate sentiment feedback data for RL model 110. RL model 110 may be further trained by feedback data from feedback model 112 and/or sentiment feedback data from sentiment model 114 and may determine to modify the decoding method to be used for the next token in the response and/or the next token to be used in the next (e.g., different and/or subsequent) response.

RL data 116 of RL model 110 may comprise a database configured to store data records. In some non-limiting embodiments or aspects, RL data 116 may store training data used to train and/or re-train RL model 110. RL data 116 may store user data associated with users interacting with LLM system 104. RL data 116 may store output from RL model 110, feedback model 112, and/or sentiment model 114. In some non-limiting embodiments or aspects, RL data 116 may store decoding methods 108a-108c. RL data 116 may store one or more reward data structures used to generate the decisions of RL model 110.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

With continued reference to FIG. 1, in some non-limiting embodiments or aspects, LLM system 104 may receive a prompt from user device 102. LLM 106 of LLM system 104 may receive the prompt. The prompt may comprise a question, a request, an inquiry, a command, and/or the like. The user may enter a prompt to a graphical user interface of user device 102 to cause user device 102 to communicate the prompt to LLM system 104. LLM system 104 may automatically generate and communicate a response to user device 102 in response to receiving the prompt as described herein. LLM system 104 may be configured to simulate how a human would behave as a conversational partner in order to interact with user device 102.

In response to receiving the prompt, user data associated with the user of user device 102 may be input to and/or retrieved from RL model 110 and used to generate the response. For example, the user data may be input to RL data 116. The user data may comprise a user identifier associated with the user. The user identifier may be received from user device 102 during the initiation of the conversation (e.g., the prompt) with LLM system 104. In some non-limiting embodiments or aspects, a user may log in to communicate with LLM system 104, which login process may identify the user and retrieve the user identifier associated therewith. In some non-limiting embodiments or aspects, a user identifier may be identified and/or retrieved based on a device identifier of user device 102. However, it will be appreciated that the user of user device 102 may be identified using any suitable method.

User data stored in RL data 116 may comprise user profile data, such as user demographic data (e.g., age, gender, race, nationality, occupation, degree, and the like). User data stored in RL data 116 may comprise historical user interaction data. Historical user interaction data may comprise, for example: a log of historical conversations of the user with LLM system 104, user feedback to previous interactions (e.g., explicit and/or implicit feedback), decoding methods used in previous user interactions, a model profile generated for the user, model confidence in the user's profile, and/or the like.

In response to receiving the prompt, LLM system 104 (e.g., LLM 106 thereof) may generate a prompt embedding corresponding to the prompt. LLM system 104, such as LLM 106 thereof, may process the prompt and generate the response based on the prompt embedding.

With continued reference to FIG. 1, RL model 110 may determine a first decoder from the plurality of decoding methods 108a-108c based at least partially on the user data. The first decoder may correspond to first decoding method 108a. The first decoder may also be determined based at least partially on the prompt received from user device 102. The first decoder may be determined by RL model 110 as the decoding method that should be used to generate at least one first token of the response to the prompt, such as the next token of the response.

In response to RL model 110 determining the first decoder for the first token, LLM 106 may generate the first token. To LLM 106 may be input the prompt (e.g., from user device 102) and an identifier identifying first decoder as the decoding method to be used by LLM 106 to generate the first token. LLM 106 may invoke first decoding method 108a (corresponding to first decoder) to generate the first token and use first decoding method 108a to generate the first token of the response based on the prompt. Using the first decoding method 108a may include executing first decoding method 108a (e.g., program instructions thereof) based on the prompt.

In some non-limiting embodiments or aspects, the first token may correspond to at least one word, part of a word (e.g., letter or string of letters), phrase (e.g., string of words), number, character, and/or the like. For example, each token may correspond to a single word.

LLM 106 may generate the response based on one or more tokens generated as described herein. For example, first token to n^{th} token may be generated by LLM 106, and each token may be replaced by the corresponding word and/or phrase to form the response. The response may comprise the first token (e.g., the word and/or phrase corresponding thereto) or a string of tokens (e.g., the words and/or phrases corresponding thereto), such as a first token, a second token, an n^{th} token. Thus, the response may comprise a word or phrase and/or a string of words or phrases corresponding to the tokens generated for the response. In response to all tokens being generated and replaced with the corresponding word and/or phrase to form the response, the response may be communicated from LLM system 104 (e.g., LLM 106) to user device 102. The response communicated to user device 102 may be displayed on a graphical user interface of user device 102 and/or emitted as sound for the user to hear the response.

With continued reference to FIG. 1, in some non-limiting embodiments or aspects, the response is formed from a plurality of tokens (e.g., a string of tokens). In response to LLM 106 generating the first token, RL model 110 may determine a second decoder from the plurality of decoding methods 108a-108c. The second decoder may be determined based at least partially on at least one of the following: the user data, the prompt, the portion of the response already generated, feedback data, and/or sentiment feedback data. The second decoder may be the same as the first decoder (e.g., correspond to first decoding method 108a). The second decoder may be different as the first decoder (e.g., correspond to a different decoding method such as the second or third decoding method 108b-108c). The second decoder may be determined by RL model 110 as the decoding method that should be used to generate at least one second token of the response to the prompt.

In response to RL model 110 determining the second decoder for the second token, LLM 106 may generate the second token. LLM 106 may generate the second token based on the prompt (e.g., from user device 102), the portion of the response already generated, and/or an identifier identifying second decoder as the decoding method to be used by LLM 106 to generate the second token. LLM 106 may invoke the decoding method corresponding to second decoder. Using the corresponding decoding method may include executing program instructions thereof based on the prompt.

LLM 106 may generate the response based on the first token and the second token (and any tokens from the second token to the n^{th} token). The response may string together the first and second tokens (e.g., the words and/or phrase corresponding thereto). The foregoing process may be repeated for the third through n^{th} token until the response is completed. Thus, the decoding method may be determined by RL model 110 for each next token to be generated for the response to enable dynamic changing of the most suitable decoding method during generation of the response, which may improve LLMs and responses generated thereby.

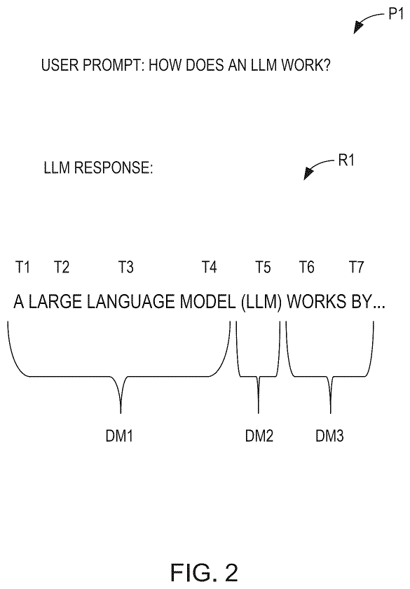

FIG. 2 shows a schematic diagram of an LLM-generated response, according to some non-limiting embodiments or aspects. Referring to FIGS. 1 and 2, LLM 106 may receive a first prompt P1 from user device 102. In this non-limiting example, first prompt P1 may be: “How does an LLM work?”.

In response to receiving first prompt P1, LLM system 104 may automatically generate a first response R1. In this non-limiting example, first response R1 may be: “A large language model (LLM) works by . . . .” As shown in FIG. 2, first response R1 may be formed from at least 7 tokens T1-T7, and the words and/or phrases corresponding to those tokens T1-T7 may be strung together to form first response R1. In this non-limiting example, first response R1 may be generated using a plurality of different decoding methods (DM1-DM3, which may correspond to decoding methods 108a-108c as previously described). For example, tokens T1-T4 may be generated using first decoding method DM1, token T5 may be generated using second decoding method DM2, and tokens T6-T7 may be generated using third decoding method DM3.

Prior to generation of token T1, RL model 110 may determine that DM1 is the decoding method to be used for token T1. In between each token (e.g., between T1 and T2), RL model 110 may again determine the next decoding method from the plurality of decoding methods DM1-DM3 to be used for the next token.

From the non-limiting example of first response R1 shown in FIG. 2, it will be appreciated that any combination or arrangement of decoding methods DM1-DM3 may be used to generate a response. For example, a response may be generated using a single decoding method (e.g., same decoding method for every token generated). A response may be generated using any number or combination of decoding methods.

Referring to FIGS. 1 and 3-5C, in some non-limiting embodiments or aspects, determining a decoding method (e.g. by RL model 110) may be based at least partially on feedback data as described hereinafter. In some non-limiting embodiments or aspects, the feedback may be received during generation of the response, such as in between the generation of one or more tokens. Such feedback may enable a change in decoding method during the course of response generation, and the response may be generated using a plurality of decoding methods. In some non-limiting embodiments or aspects, the feedback may be received after generation of the response and/or after transmission of the response to user device 102. Such feedback may enable a change in decoding method and/or the selection of the decoding method for future response generation.

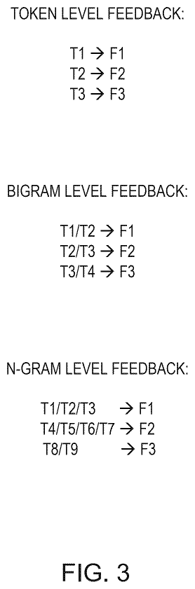

Referring to FIG. 3, feedback is shown at several different levels, and such feedback may be generated during the generation of the response. Referring to FIGS. 1 and 3, in some non-limiting embodiments or aspects, the feedback may be generated by RL model 110. The feedback generated may be based on data stored in RL data 116 and/or an output from feedback model 112.

In some non-limiting embodiments or aspects, feedback data may be generated at the token level. For example, in response to LLM 106 generating first token T1 (and before generation of second token T2), RL model 110 may generate first feedback F1; in response to LLM 106 generating second token T2 (and before generation of third token T3), RL model 110 may generate second feedback F2; in response to LLM 106 generating third token T3 (and before generation of a next token), RL model 110 may generate third feedback F3. Second token T2 may be generated based at least in part on first feedback F1. Third token T3 may be generated based at least in part on first and/or second feedback F1, F2.

In some non-limiting embodiments or aspects, feedback data may be generated at the bigram level. A bigram may refer to a combination of two consecutive tokens. For example, in response to LLM 106 generating first bigram T1/T2 (and before generation of second bigram T2/T3), RL model 110 may generate first feedback F1; in response to LLM 106 generating second bigram T2/T3 (and before generation of third bigram T3/T4), RL model 110 may generate second feedback F2; in response to LLM 106 generating third bigram T3/T4 (and before generation of a next bigram), RL model 110 may generate third feedback F3. Third token T3 of second bigram T2/T3 may be generated based at least in part on first feedback F1. Fourth token T4 of third bigram T3/T4 may be generated based at least in part on first and/or second feedback F1, F2.

In some non-limiting embodiments or aspects, feedback data may be generated at the n-gram level. An n-gram may refer to a combination of n consecutive tokens, and n may be any number greater than or equal to 2. For example, in response to LLM 106 generating first n-gram T1/T2/T3 (and before generation of second n-gram T4/T5/T6/T7), RL model 110 may generate first feedback F1; in response to LLM 106 generating second n-gram T4/T5/T6/T7 (and before generation of third n-gram T8/T9), RL model 110 may generate second feedback F2; in response to LLM 106 generating third n-gram T8/T9 (and before generation of a next n-gram), RL model 110 may generate third feedback F3. Fourth token T4 of second n-gram T4/T5/T6/T7 may be generated based at least in part on first feedback F1. Eighth token T8 of third n-gram T8/T9 may be generated based at least in part on first and/or second feedback F1, F2.

From the non-limiting examples shown in FIG. 3, it will be appreciated that feedback data may be generated in between tokens and/or strings of tokens (e.g., bigrams and n-grams), and such feedback data may be used in selecting the next decoding method for the next token or string of tokens. The feedback data generated during generation of the response and used in selecting the next decoding method for the next token enables LLM system 104 to improve responses generated by LLM 106. This feedback data may be generated by feedback model 112.

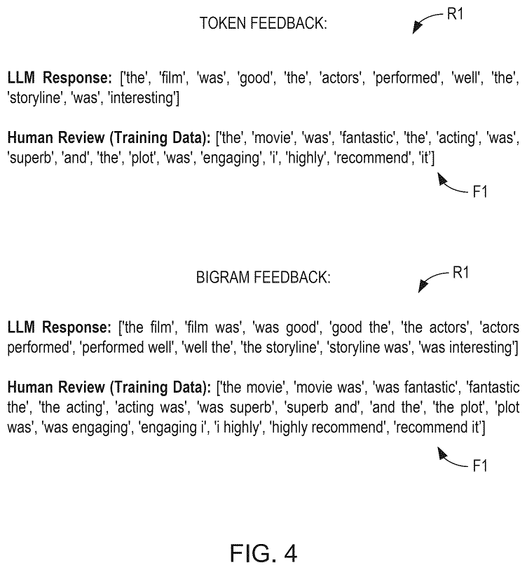

Referring to FIG. 4, non-limiting examples of token level and bigram level feedback are shown, in some non-limiting embodiments or aspects.

In the non-limiting example of token level feedback, LLM 106 generated the first response R1: “[‘the’, ‘film’, ‘was’, ‘good’, ‘the’, ‘actors’, ‘performed’, ‘well’, ‘the’, ‘storyline’, ‘was’, ‘interesting’].” RL model 110 may comprise training data (e.g., stored in RL data 116) including the following similar response as first feedback F1: “[‘the’, ‘movie’, ‘was’, ‘fantastic’, ‘the’, ‘acting’, ‘was’, ‘superb’, ‘and’, ‘the’, ‘plot’, ‘was’, ‘engaging’, ‘i’, ‘highly’, ‘recommend’, ‘it’].” First feedback F1 may comprise a human annotated response used to train and/or re-train RL model 110. First feedback F1 may be used by LLM 106 during and/or after the generation of first response R1 to improve the responses generated by LLM 106. First feedback F1 and first response R1 may be compared at the token level to improve the generation of the next token in first response R1 (during generation thereof) and/or to improve future responses of LLM 106 to similar prompts.

In the non-limiting example of bigram level feedback, LLM 106 generated the same first response R1, and the first feedback F1 from RL model 110 is in bigram form: [‘the movie’, ‘movie was’, ‘was fantastic’, ‘fantastic the’, ‘the acting’, ‘acting was’, ‘was superb’, ‘superb and’, ‘and the’, ‘the plot’, ‘plot was’, ‘was engaging’, ‘engaging i’, ‘i highly’, ‘highly recommend’, ‘recommend it’]. First feedback F1 may be used by LLM 106 during and/or after the generation of first response R1 to improve the responses generated by LLM 106. First feedback F1 and first response R1 may be compared at the bigram level to improve the generation of the next token (and/or bigram and/or n-gram) in first response R1 (during generation thereof) and/or to improve future responses of LLM 106 to similar prompts.

Referring to FIGS. 1-4, the feedback described herein may be generated during generation of the response and be used in generation of tokens generated after generation of the feedback. For example, as previously described, LLM 106 may generate first token T1 of first response R1, such as based at least partially on user data. In response to generation of first token T1 and before generation of second token T2, first feedback F1 may be generated. First feedback F1 may be generated by and/or provided to RL model 110. First feedback F1 may be generated by and/or provided to RL model 110 after generation of first Token T1 and before determination of a decoding method to be used for second token T2 (e.g., in between both events). RL model 110 may determine the decoding method to be used for token T2 based at least partially on first feedback F1.

In some non-limiting embodiments or aspects, feedback data may be generated by and/or provided to the RL model 110 in between each token generated by the LLM 106 (e.g., between T1 and T2, between T2 and T3, and the like). Each token generated may be generated based at least partially on feedback data generated before or during generation of first response R1.

The feedback data may comprise any data suitable for use as input to determine the most suitable decoding method to be used for the next token.

In some non-limiting examples, the feedback data may comprise an n-gram comparison of a human generated (e.g., annotated) response (described in FIG. 4) to a portion of the response generated by LLM 106 where n is 1 or more. Thus, the n-gram comparison may be executed at the token level (where n is 1), the bigram level (where n is 2), the n-gram level (where n is 2 or more), and/or any combination thereof.

In some non-limiting examples, the feedback data may comprise a perplexity score representing a confidence (e.g., likelihood) of LLM 106 in predicting a next token (or tokens) of the response. A model having high confidence in its predictions may have a low perplexity score, while a model having low confidence in its predictions may have a high perplexity score.

In some non-limiting examples, the feedback data may comprise at least one of the following scores: a Bilingual Evaluation Understudy (BLEU) score, a Recall-Oriented Understudy for Gisting Evaluation (ROUGE) score, a Metric for Evaluation of Translation with Explicit Ordering (METEOR) score, a Word Error Rate (WER) score, a Character Error Rate (CER) score, and/or any combination thereof (hereinafter “other metrics”).

The BLEU protocol may evaluate fluency by comparing generated text to reference human-written text. The ROUGE protocol may focus on recall and be used for text summarization and/or fluency evaluation. The METEOR protocol may assess fluency based on precision, recall, and/or synonymy. The WER protocol may calculate the percentage of words incorrectly transcribed or generated, such that a lower WER indicates better fluency. The CER protocol operates similar to WER but at the character level.

The feedback data may comprise any combination of 1 or 2 or more of the foregoing types of feedback data (n-gram comparison, perplexity score, other metrics).

For example, a feedback score may be generated using the foregoing types of feedback data according to the following equation:

$$FS = α ( NG ) + β ( P ) + γ ( OM )$$

where FS is feedback score, NG is a normalized n-gram score, P is a normalized perplexity score, OM is a normalized other metric score, and α, β, and γ represent weights based on relevance of each metric to the use case.

A metric may be normalized according to the following equation:

$$Normalized\_Metric = ( Current\_Metric \_Value - Min\_Metric \_Value ) / ( Max\_Metric \_Value - Min\_Metric \_Value ) .$$

With continued reference to FIG. 4, first response R1 (and/or a portion thereof) may be compared to first feedback F1 (and/or a portion thereof) to evaluate first response R1. The evaluation may involve generating a vocabulary of unique tokens and/or bigrams and/or n-grams, count an occurrence of unique tokens and/or bigrams and/or n-grams, represent the frequency counts as numerical vectors, and compute a similarity (e.g., cosine similarity) between the two frequency vectors. The similarity score may be used to continue to train RL model 110 and enable RL model 110 to select the best next decoding method for the next token.

In some non-limiting embodiments or aspects, this feedback data generated during generation of first response R1 may be generated and/or analyzed by feedback model 112. Feedback model 112 (e.g. the output thereof) may be used to further train and/or improve RL model 110. The feedback data generated by the feedback model 112 may function as a reward and/or a penalty to RL model 110 based on the nature of the feedback data.

In some non-limiting embodiments or aspects, the generated feedback data may be stored in RL data 116 and may be used to train and/or re-train RL model 110. RL data 116 may store the human annotated feedback used to analyze first response R1 and provide first feedback F1. LLM system 104 may have a training component comprising data configured to generate feedback, and/or train or retrain RL model 110 and may comprise a separate component configured to generate responses to prompts (e.g., LLM 106). The training component and response-generating component may dynamically interact during generation of the response (e.g., between token generation) to improve the responses.

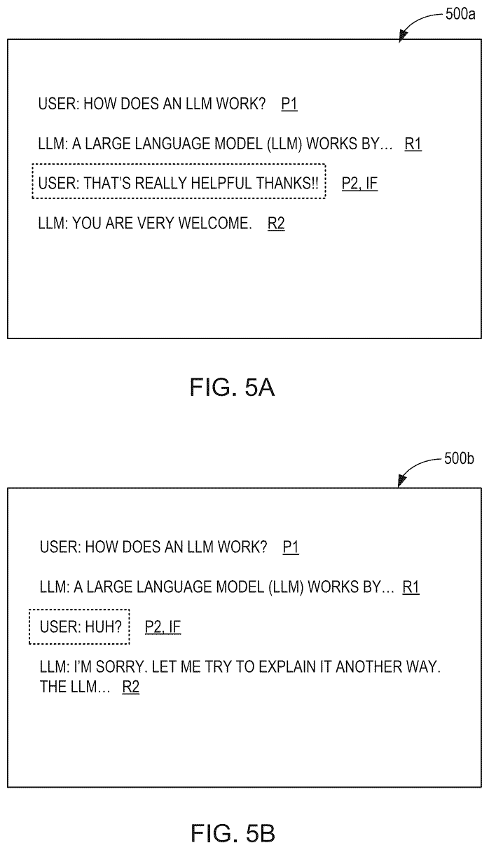

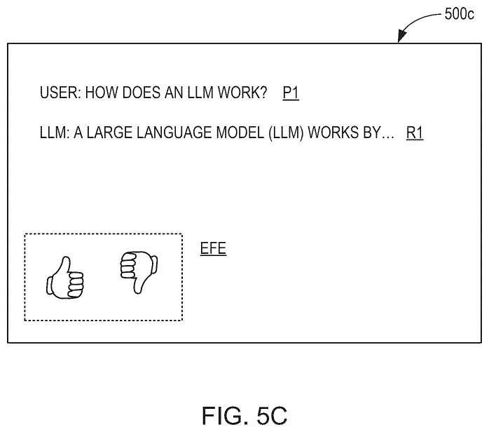

Referring to FIGS. 5A-5C, shown are user interfaces for receiving user feedback data, according to some non-limiting embodiments or aspects. Referring to FIGS. 1 and 5A-5C, the user feedback data may comprise explicit and/or implicit feedback from the user of user device 102. The user feedback data may reflect user sentiment regarding the user's interaction with LLM system 104. User feedback data may interchangeably be referred to as sentiment feedback data. Sentiment feedback data may be received by LLM system 104 after LLM system 104 communicates a response to user device 102, and sentiment feedback data may reflect the user's opinion of the received response.

After communicating a response to user device 102, LLM system 104 (e.g., LLM 106 thereof) may receive sentiment feedback data from user device 102. The sentiment feedback data may be associated with the response communicated to user device 102 and reflect the user's opinion of the received response. The received sentiment feedback data may be received and analyzed by sentiment model 114 to generate further sentiment feedback data that may be used to train and/or retrain RL model 110. Because the sentiment feedback data is received after generating and communicating the response, the sentiment feedback data may be used to improve future responses to the user or other users, including improving future responses to that same user within the same interaction (e.g. continuing conversation between user device 102 and LLM system 104).

Referring to FIGS. 1, 5A, and 5B, show an interaction between a user and LLM system 104 that includes a back-and-forth conversation with multiple prompts P1, P2 and multiple responses R1, R2. FIGS. 5A and 5B show graphical user interfaces 500a, 500b on which the conversation may be viewable by the user on user device 102, although it will be appreciated that other means of interaction may also be used (e.g., a speaker of user device 102 reading the interaction to the user).

In the interactions shown in FIGS. 5A and 5B, user may submit a first prompt P1 from user device 102 to LLM system 104 as shown and described herein. In response to receiving first prompt P1, LLM system 104 may automatically generate and communicate a first response R1 to user device 102.

In response to receiving first response R1, user may generate a second prompt P2 using user device 102, which may communicate second prompt P2 to LLM system 104. In response to receiving second prompt P2, LLM system 104 may automatically generate a second response R2 and communicate second response to user device 102. Second response R2 may be generated by inputting user feedback data as described herein to RL model 110. The feedback data may comprise feedback data from feedback model 112 and/or sentiment feedback data from sentiment model 114 as described herein. RL model 110 may be trained on the input feedback data. Second response R2 may be generated by determining a second decoding method from the plurality of decoding methods based at least partially on the feedback data. RL model 110 may determine the second decoding method, and the second decoding method may be the decoding method determined by the RL model 110 as the best decoding method for generating the next token of second response R2.

Second prompt P2 may be input to LLM 106. An identifier of the second decoding method may be input to LLM 106 to instruct LLM 106 as to the decoding method to be used to generate the next token. LLM 106 may generate a first token of second response R2 based at least partially on second prompt P2 and using the second decoding method, such as by invoking and/or executing second decoding method 108b. Second response R2 may comprise a string of tokens (and/or the corresponding words and/or phrases correspond to those tokens). The tokens of second response R2 may be generated using a single decoding method, or different decoding methods may be used to generate different tokens from second response R2. Second response R2 may be generated by LLM 106 and communicated to user device 102. Second response R2 may be displayed on graphical user interface 500a, 500b.

It will be appreciated that user device 102 and LLM system 104 may continue to engage in a dialog until user and/or LLM system 104 ends the conversation. Thus, user device 102 may submit a third prompt, fourth prompt, nth prompt, and LLM 106 may automatically respond with a third response, fourth response, nth response.

With continued reference to FIGS. 1, 5A, and 5B, implicit feedback data IF may be received by LLM system 104 and may be analyzed by sentiment model 114 to further train and/or improve RL model 110. The implicit feedback data IF may comprise feedback data inferred by LLM system 104 (e.g., sentiment model 114 thereof) from second prompt P2 received from user device 102 after user device 102 receives first response R1. Thus, LLM system 104 may infer user sentiment based on the contents of prompts submitted by the user. User sentiment may refer to whether the user has a positive, negative, and/or neutral view of one or more of LLM system's 104 responses, such as the response being at least one of: good, bad, helpful, not helpful, clear, confusing, correct, incorrect thorough, cursory, overcomplicated, oversimplified, average, and the like, or any combination thereof. The implicit feedback IF may function as a reward and/or a penalty to RL model 110 based on the nature of the feedback.

For example, FIGS. 5A and 5B have an identical first prompt P1 and first response R1, but user responds to first response R1 differently in FIG. 5A compared to FIG. 5B such that second prompt P2 (responding to first response R1) is different. In each case, second prompt P2 may also comprise implicit feedback data IF which may be analyzed by sentiment model 114 to determine a user sentiment towards first response R1 (or any other prior response in the conversation or the conversation more generally).

For example, in FIG. 5A, sentiment model 114 may infer from the implicit feedback data IF of second prompt P2 that its first response R1 was favorably received by the user (e.g., the user found first response R1 helpful and/or is enthusiastic regarding first response R1). Second response R2 may be generated based at least in part on second prompt P2 and the implicit feedback data IF implied from second prompt P2.

For example, in FIG. 5B, sentiment model 114 may infer from the implicit feedback data IF of second prompt P2 that its first response R1 was not favorably received by the user (e.g., the user found first response R1 unhelpful and/or confusing and/or incorrect). Second response R2 may be generated based at least in part on second prompt P2 and the implicit feedback data IF implied from second prompt P2.

Referring to FIGS. 1 and 5C, user device 102 may be provided with an explicit feedback element EFE configured to receive explicit user feedback from the user. For example, explicit feedback element EFE may be displayed on graphical user interface 500c. The non-limiting example of FIG. 5C shows a “thumbs-up” and “thumbs-down” element configured to be selected by the user to express an explicit sentiment regarding a response (e.g., first response R1). For example, user selection of the “thumbs-up” element may express explicit user approval of first response R1, while user selection of the “thumbs-down” element may express explicit user disapproval of first response R1. Any suitable explicit feedback element EFE configured to receive explicit user feedback may be used. For example, the explicit feedback element EFE may comprise at least one of the following: a user input in which at least one parameter of LLM 106 (including LLM system 104) is tuned, a user input indicating direct approval or disapproval of the response, and/or any combination thereof. The explicit feedback may function as a reward and/or a penalty to RL model 110 based on the nature of the feedback.

The explicit feedback may be received by LLM system 104 and may be analyzed by sentiment model 114 to further train and/or improve RL model 110. The explicit feedback may comprise explicit feedback data generated by LLM system 104 (e.g., sentiment model 114 thereof) in response to the user interacting with explicit feedback element EFE. A further response (as part of the same conversation or a different conversation) may be generated based at least in part the explicit feedback.

Referring again to FIGS. 1-5C, it will be appreciated that feedback generation (e.g., from feedback model 112 and/or sentiment model 114) and token and/or response generation may be executed by LLM system 104 as a dynamic and/or iterative process. The process may be executed in between token generation within a single response and/or between sequentially generated responses.

For example, in response to receiving a prompt from user device 102, RL model 110 may determine a first decoder corresponding to a decoding method to be used by LLM 106 for generating a first token of the first response. In response to generating the first token of the first response, RL model 110 may generate and/or receive feedback data associated with the first token generated. RL model 110 may determine a second decoder corresponding to a decoding method to be used by LLM 106 for generating a second token of the first response, which second decoder may correspond to the same decoding method or correspond to a different decoding method (e.g., dynamically switching decoding methods during generation of the first response). The decoding method may be selected for the next token based on which decoding method would maximize the reward to the RL model 110 (based on the feedback data). The second decoder may be determined by RL model 110 based on the feedback generated and/or received after the first token was generated. This iterative process may continue during generation of the first response and may improve the first response compared to an LLM system that does not include RL model 110 that controls selection of the decoding methods to be used by an LLM.

For example, in response to receiving a first response from LLM system 104, RL model 110 may receive and/or generate feedback data. The feedback data received by RL model 110 may comprise explicit or implicit feedback data received from user device 102 based on user's input to user device 102. The feedback data may be generated by feedback model 112, such as by comparing first response to training data. RL model 110 may be further trained based on the feedback data generated and/or received in response to and/or after communicating the first response to user device 102. In response to receiving a subsequent prompt (from the same user or a different user and/or as part of the same conversation or a different conversation), LLM system 104 may generate a second response. The second response may be generated by LLM system 104 based at least in part on the second prompt and the feedback data received after the first response. For example, the feedback data received after the first response may be used by RL model 110 to determine a first token of the second response. LLM system 104 and RL model 110 thereof may continue to learn from feedback data in order to improve responses generated to future prompts.

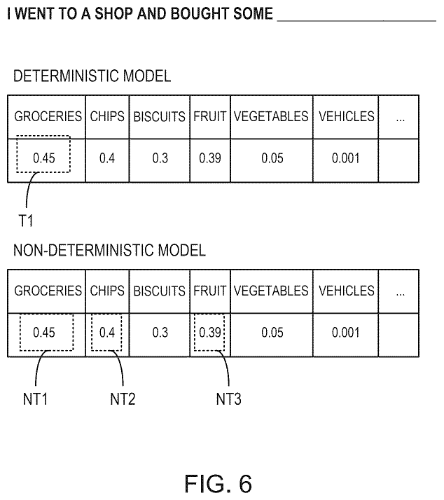

Referring to FIG. 6, non-limiting examples of decoding methods that may be used by LLM 106 are shown, according to some non-limiting embodiments or aspects.

In some non-limiting embodiments or aspects, a deterministic decoding method may be used. A deterministic decoding method may comprise a decoding method in which the token automatically selected (e.g., generated) thereby is selected from a plurality of potential tokens, where the token selected from the plurality of potential tokens by the method has a highest relevance score compared to the non-selected tokens from the plurality of potential tokens.

For example, in FIG. 6, the response is “I went to a shop and bought some _____”, where a token is generated by a decoding method to determine the next word in the response. According to the deterministic decoding method shown, a plurality of potential tokens can be used to complete the response: “groceries”, “chips”, “biscuits”, “fruit”, “vegetables”, and “vehicle”. For each of the plurality of tokens, a relevance score may be generated, and LLM 106 may generate the relevance score for each potential token. In the deterministic model, because “groceries” is the token having the highest relevance score, “groceries” is automatically the token T1 generated to complete the response.

Non-limiting examples of deterministic decoding methods may comprise the Greedy decoding method, Beam search decoding method, and the like.

In some non-limiting embodiments or aspects, a non-deterministic decoding method may be used. A non-deterministic decoding method may comprise a decoding method in which the token selected (e.g., generated) thereby is selected from a plurality of potential tokens, where the token selected from the plurality of potential tokens by the method may be generated based on the first token being selected (e.g., randomly) from a subset of n-tokens of the plurality of tokens. The subset of n-tokens may have a higher relevance scored compared to other tokens from the plurality of tokens, where n is 2 or more. The non-deterministic decoding method may produce different outputs for the same input.

For example, in FIG. 6, the response is “I went to a shop and bought some ______”, where a token is generated by a decoding method to determine the next word in the response. According to the non-deterministic decoding method shown, a plurality of potential tokens can be used to complete the response: “groceries”, “chips”, “biscuits”, “fruit”, “vegetables”, and “vehicle”. For each of the plurality of tokens, a relevance score may be generated, and LLM 106 may generate the relevance score for each potential token. In the non-deterministic model, the top n tokens (in this case n is 3) include “groceries” NT1, “chips” NT2, and “fruit” NT3, and the token generated to complete the response may be selected (e.g., randomly) from the subset of NT1-NT3.

Non-limiting examples of non-deterministic decoding methods may comprise a top-k random sampling decoding method, nucleus sampling decoding method, and the like.

In some non-limiting embodiments or aspects, a hybrid of deterministic and non-deterministic decoding methods may be used.

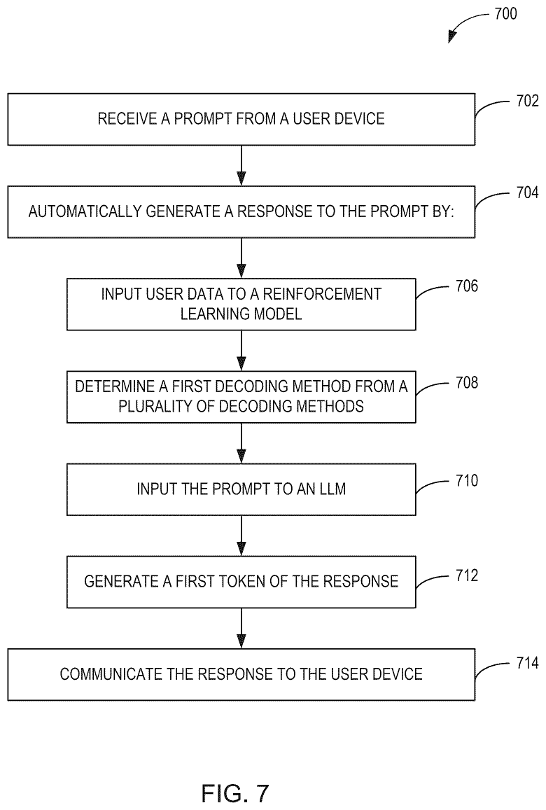

Referring now to FIG. 7, shown is a process 700 for improving LLMs, according to some non-limiting embodiments or aspects. The steps shown in FIG. 7 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 7, at step 702, a prompt may be received from a user device. For example, LLM system 104 may receive a prompt from user device 102.

As shown in FIG. 7, at step 704, in response to receiving the prompt, a response to the prompt may be automatically generated. For example, LLM system 104 may automatically generate the response, such as using LLM 106, RL model 110 (and its subcomponents), and/or decoding methods 108a-108c.

As shown in FIG. 7, at step 706, automatically generating the response may include inputting user data associated with the user to a reinforcement learning model. For example, user data of the user of user device 102 may be input to RL model 110 of LLM system 104.

As shown in FIG. 7, at step 708, automatically generating the response may include determining a first decoding method from a plurality of decoding methods based at least partially on the user data. For example, RL model 110 may select a first decoding method 108a from a plurality of decoding methods 108a-108c.

As shown in FIG. 7, at step 710, automatically generating the response may include inputting the prompt to a large language model (LLM). For example, the prompt may be input to LLM 106 of LLM system 104.

As shown in FIG. 7, at step 712, automatically generating the response may include generating a first token of the response based at least partially on the prompt and using the first decoding method. For example, LLM 106 may generate the first token using first decoding method 108a based on the prompt.

As shown in FIG. 7, at step 714, the response may be communicated to the user device. For example, LLM system 104, such as LLM 106 thereof, may communicate the response to user device 102.

In some non-limiting embodiments or aspects, one or more of the steps of process 700 may be performed (e.g., completely, partially, and/or the like) by LLM system 104 (e.g., one or more devices of LLM system 104, such as by LLM 106, DM data 107, decoding methods 108a-108c, RL model 110, feedback model 112, sentiment model 114, and/or RL database 116). In some non-limiting embodiments or aspects, one or more of the steps of process 700 may be performed (e.g., completely, partially, and/or the like) by another system, another device, another group of systems, or another group of devices, separate from or including LLM system 104, such as user device 102.

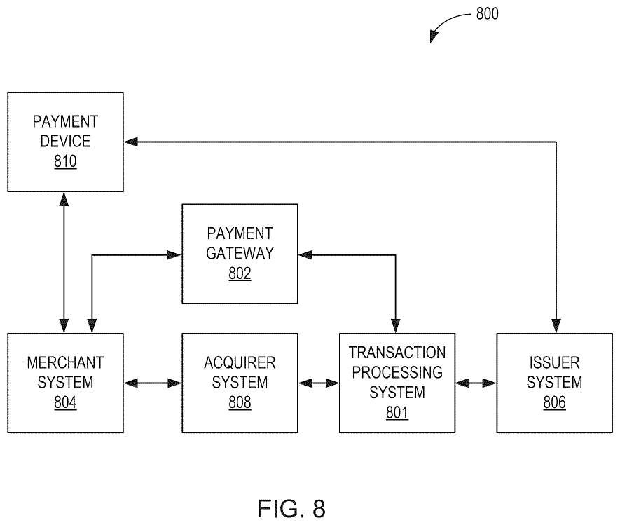

FIG. 8 shows an electronic payment processing network 800 according to non-limiting embodiments or aspects. The payment processing network may be used in conjunction with the systems and methods described herein. It will be appreciated that the particular arrangement of electronic payment processing network 800 shown is for example purposes only, and that various arrangements are possible. Transaction processing system 801 (e.g., a transaction handler) is shown to be in communication with one or more issuer systems (e.g., such as issuer system 806) and one or more acquirer systems (e.g., such as acquirer system 808). Although only a single issuer system 806 and single acquirer system 808 are shown, it will be appreciated that transaction processing system 801 may be in communication with a plurality of issuer systems and/or acquirer systems. In some embodiments, transaction processing system 801 may also operate as an issuer system such that both transaction processing system 801 and issuer system 806 are a single system and/or controlled by a single entity.

In some non-limiting embodiments or aspects, transaction processing system 801 may communicate with merchant system 804 directly through a public or private network connection. Additionally or alternatively, transaction processing system 801 may communicate with merchant system 804 through payment gateway 802 and/or acquirer system 808. In some non-limiting embodiments or aspects, an acquirer system 808 associated with merchant system 804 may operate as payment gateway 802 to facilitate the communication of transaction requests from merchant system 804 to transaction processing system 801. Merchant system 804 may communicate with payment gateway 802 through a public or private network connection. For example, a merchant system 804 that includes a physical POS device may communicate with payment gateway 802 through a public or private network to conduct card-present transactions. As another example, a merchant system 804 that includes a server (e.g., a web server) may communicate with payment gateway 802 through a public or private network, such as a public Internet connection, to conduct card-not-present transactions.

In some non-limiting embodiments or aspects, transaction processing system 801, after receiving a transaction request from merchant system 804 that identifies an account identifier of a payor (e.g., such as an account holder) associated with an issued payment device 810, may generate an authorization request message to be communicated to the issuer system 806 that issued the payment device 810 and/or account identifier. Issuer system 806 may then approve or decline the authorization request and, based on the approval or denial, generate an authorization response message that is communicated to transaction processing system 801. Transaction processing system 801 may communicate an approval or denial to merchant system 804. When issuer system 806 approves the authorization request message, it may then clear and settle the payment transaction between the issuer system 806 and acquirer system 808.

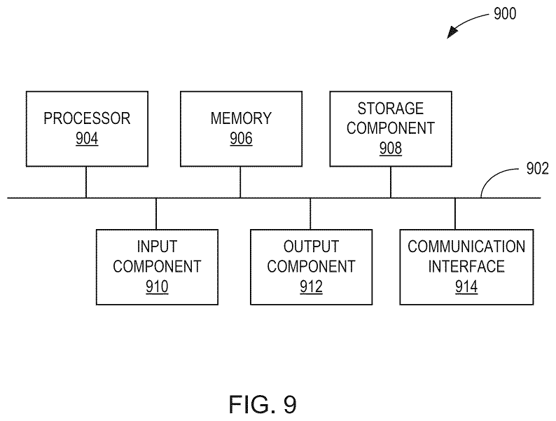

Referring now to FIG. 9, shown is a diagram of example components of a device 900 according to non-limiting embodiments or aspects. Device 900 may correspond to at least one of user device 102, LLM system 104, LLM 106, DM data 107, decoding methods 108a-108c, RL model 110, feedback model 112, sentiment model 114, RL data 116 and/or any other computing device shown and described herein. In some non-limiting embodiments or aspects, such systems or devices may include at least one device 900 and/or at least one component of device 900. The number and arrangement of components shown in FIG. 9 are provided as an example. In some non-limiting embodiments or aspects, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

As shown in FIG. 9, device 900 may include bus 902, processor 904, memory 906, storage component 908, input component 910, output component 912, and communication interface 914. Bus 902 may include a component that permits communication among the components of device 900. In some non-limiting embodiments or aspects, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 9, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

In some non-limiting embodiments or aspects, a computer program product for improving LLMs includes at least one non-transitory computer readable medium including program instructions that, when executed by at least one processor, cause the at least one processor to execute one of the previously-described methods. The at least one processor may include any of the components shown in FIG. 1.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
receiving, with a large language model system, a prompt from a user device of a user;
in response to receiving the prompt, automatically generating, with the large language model system, a response to the prompt by:
inputting user data associated with the user to a reinforcement learning model of the large language model system;
determining, with the reinforcement learning model, a first decoding method from a plurality of decoding methods based at least partially on the user data;
inputting the prompt to a large language model (LLM) of the large language model system; and
generating, with the LLM, a first token of the response based at least partially on the prompt and using the first decoding method; and
communicating, with the large language model system, the response to the user device.

2. The computer-implemented method of claim 1, wherein the first token corresponds to at least one word or phrase of the response.

3. The computer-implemented method of claim 1, wherein the first decoding method comprises a deterministic decoding method, wherein the first token is a token selected from a plurality of tokens, wherein the first token is generated based on the first token having a highest relevance scored compared to other tokens from the plurality of tokens.

4. The computer-implemented method of claim 1, wherein the first decoding method comprises a non-deterministic decoding method, wherein the first token is a token selected from a plurality of tokens, wherein the first token is generated based on the first token being randomly selected from a subset of n-tokens of the plurality of tokens, the subset of n-tokens having a higher relevance scored compared to other tokens from the plurality of tokens, wherein n is 2 or more.

5. The computer-implemented method of claim 1, wherein automatically generating the response to the prompt further comprises:
in response to generating the first token, determining, with the reinforcement learning model, a second decoding method from the plurality of decoding methods; and
generating, with the LLM, a second token of the response based at least partially on the prompt and using the second decoding method.

6. The computer-implemented method of claim 5, wherein the response comprises a string of words and/or phrases corresponding to the first token and the second token.

7. The computer-implemented method of claim 5, wherein the second decoding method is different from the first decoding method.

8. The computer-implemented method of claim 5, wherein determining the second decoding method is based at least partially on feedback data, the feedback data generated by and/or provided to the reinforcement learning model in between the generation of the first token and the determination of the second decoding method.

9. The computer-implemented method of claim 8, wherein the feedback data comprises at least one of the following:
an n-gram comparison of a human-generated response to a portion of the response generated by the LLM, wherein n is 1 or more;
a perplexity score representing a confidence of the LLM in predicting a next token of the response;
at least one of the following scores: a Bilingual Evaluation Understudy (BLEU) score, a Recall-Oriented Understudy for Gisting Evaluation (ROUGE) score, a Metric for Evaluation of Translation with Explicit Ordering (METEOR) score, a Word Error Rate (WER) score, a Character Error Rate (CER) score, and/or any combination thereof; and/or
any combination thereof.

10. The computer-implemented method of claim 9, wherein the feedback data comprises a feedback score based on an algorithm weighting the n-gram comparison, the perplexity score, and the at least one of the following scores.

11. The computer-implemented method of claim 8, wherein the feedback data is generated by and/or provided to the reinforcement learning model in between each token generated by the LLM.

12. The computer-implemented method of claim 1, wherein the user data comprises user profile data and/or historical user interaction data.

13. The computer-implemented method of claim 1, further comprising:
after communicating the response to the user device, receiving, with the large language model system and from the user device, user feedback data associated with the response; and
training the reinforcement learning model based on the user feedback data.

14. The computer-implemented method of claim 13, further comprising:
receiving, with the large language model system, a second prompt from the user device of the user;
in response to receiving the second prompt, automatically generating, with the large language model system, a second response to the second prompt by:
inputting the user feedback data to the reinforcement learning model;
determining, with the reinforcement learning model, a second decoding method from the plurality of decoding methods based at least partially on the user feedback data;
inputting the second prompt to the LLM; and
generating, with the LLM, a first token of the second response based at least partially on the second prompt and using the second decoding method.

15. The computer-implemented method of claim 13, wherein the user feedback data comprises explicit feedback data comprising at least one of the following: a user input in which at least one parameter of the LLM is tuned, a user input indicating direct approval or disapproval of the response, and/or any combination thereof.

16. The computer-implemented method of claim 13, wherein the user feedback data comprises implicit feedback data comprising feedback inferred by the large language model system from a second prompt received from the user device after the user device receives the response.

17. The computer-implemented method of claim 1, wherein the LLM is a generative artificial intelligence model configured to generate the response in real time relative to receiving the prompt.

18. The computer-implemented method of claim 1, wherein a first portion of the response is generated by the LLM using the first decoding method, and a second portion of the response is generated by the LLM using a second decoding method different from the first decoding method.

19. A system, comprising a large language model system configured to:
receive a prompt from a user device of a user;
in response to receiving the prompt, automatically generate a response to the prompt by:
inputting user data associated with the user to a reinforcement learning model of the large language model system;
determining, with the reinforcement learning model, a first decoding method from a plurality of decoding methods based at least partially on the user data;
inputting the prompt to a large language model (LLM) of the large language model system; and
generating, with the LLM, a first token of the response based at least partially on the prompt and using the first decoding method; and
communicate the response to the user device.

20. A computer program product comprising at least one non-transitory computer-readable medium including program instructions that, when executed by a large language model system, cause the large language model system to:
receive a prompt from a user device of a user;
in response to receiving the prompt, automatically generate a response to the prompt by:
inputting user data associated with the user to a reinforcement learning model of the large language model system;
determining, with the reinforcement learning model, a first decoding method from a plurality of decoding methods based at least partially on the user data;
inputting the prompt to a large language model (LLM) of the large language model system; and
generating, with the LLM, a first token of the response based at least partially on the prompt and using the first decoding method; and
communicate the response to the user device.
